(19) United States
(12) Patent Application Publication
(10) Pub. No.: US 2019/0098120 A1
(43) Pub. Date: Mar. 28, 2019

(54) Screen protector and a method for location protector pasting for mobile phones

(71) Applicant: Zhijun Deng, Shenzhen (CN)

(72) Inventor: Zhijun Deng, Shenzhen (CN)

(21) Appl. No.: 15/918,571

(22) Filed: Mar. 12, 2018

(30) Foreign Application Priority Data
Sep. 27, 2017 (CN) 201710889312.6

(51) Int. Cl. H04M 1/02; H04M 1/725; C09J 7/00

(52) U.S. Cl. CPC H04M 1/0266; C09J 7/00; H04M 1/72525

(57) ABSTRACT

This invention provides a screen protector and a method for location protector pasting for mobile phones, which includes a position alignment layer, a protector layer and a release film layer, and through the mark printed on the position alignment layer, which corresponds to that displayed on the mobile phone screen for alignment, download a screen mark diagram in the mobile phone through the WeChat or other ways, to align the mark on the position alignment layer with the mark displayed on the mobile phone screen, so as to achieve an accurate protector pasting. This method is more accurate and more economical comparing with that makes a fixture surrounding the mobile phone to fix the protector; it can achieve the correction protector pasting to all screens including plane or 3D, which is more convenient. It just needs to print any mark pattern on the surface protector to correct the pasting location on the screen, which can provide the probability to achieve different appearance effects for developers.

### TECHNICAL FIELD

This disclosure relates to the field of protector pasting for mobile phones and especially relates to a screen protector and a method for location protector pasting for mobile phones.

### BACKGROUND

Mobile phone and other electronic products have become an integral part of people's daily life, and with the constant development of technologies, its performance and appearance are also updating and improving constantly. In order to protect the mobile phone better and prevent the mobile phone screen from scratching and staining during using, people will paste a screen protector on the mobile phone screen, and the screen protector is divided into tempered glass screen protector or soft screen protector, etc. In general, the size of a screen protector will be a litter smaller than the size of the entire screen of the mobile phone, however, there are some shortcomings in the existing protector pasting methods, such as different degrees of deviations generally existing during the protector pasting, which will affect the beauty of mobile phones and even cause screen protector changes constantly due to the existing of deviations, causing a waste of screen protector. Even a skilled technician for protector pasting will make mistakes sometimes, and because of the existing of inevitable problems, a deviation will be easy to exist in protector pasting by pure manual protector pasting due to the difficult location during the pasting.

The existing screen protector and method for protector pasting are that: the screen protector for mobile phones generally has a three-layer structure, where the middle layer is the main film, used for being pasted on the mobile phone screen, and on the both sides of the main firm are sub-films, used for protecting the main film. The protector pasting for mobile phones is usually made by manual operation, including removing a corner of one of the sub-films, aligning the entire screen protector horizontally above the mobile phone screen, pasting the main film exposed on the sub-film after removing a corner on the mobile phone screen, then slowly pulling the sub-film backward, and slightly pushing the other sub-film with a card along the direction that the main film is slowly pasted on the mobile phone screen.

However, with the rapid popularization of smart big-screen mobile phones or curved screen mobile phones, the mobile phone screen also changes gradually from original multi-button type to less-button type, and there are even many all-screen mobile phones at present. In the past, there is a headphone hole in the upper part of mobile phones and a button hole in the lower part of mobile phones, in favor of position alignment. But when the all-screen is achieved, it is not convenient for position alignment with the headphone hole only and without the button hole, and customers cannot make the position alignment well when pasting, which will have a bad effect and cause a lot of waste. With the updating of mobile phone screens, the mobile phone will develop toward the direction of 3D screen, not the plane protector pasting, which will be more difficult for customers to paste the screen protector with a more difficult position alignment, and the screen protector is quite difficult to be pasted accurately by hand for 3D curved screen or all-screen mobile phones, where the screen protector will be more difficult to be pasted accurately without the reference of original holes. At present, the position of protector is corrected by a fixture on the market, and the screen protector will be pasted then, which shall be completed by many steps by customers. And it is difficult to fix on a 3D curve, and a bad pasting will also exist. Therefore, it is urgent to provide an accurate-location screen protector, to improve the success rate of protector pasting and reduce the waste.

### SUMMARY

Against the deficiencies existed in the existing technologies, this invention proposes a screen protector and a method for location protector pasting for mobile phones.

This invention, i.e. a screen protector and a method for location protector pasting for mobile phones, adopts the following technical proposal:

A screen protector, includes three layers, i.e. position alignment layer, protector layer and release film layer respectively, and the protector layer is the layer that actually protects the screen and is set between the position alignment layer and the release film layer, where the position alignment layer is set in the outer layer.

Further, the protector layer is coated with a glue layer, for pasting with the mobile phone screen, and the position alignment layer and the release film layer are set with labels respectively.

Further, the position alignment layer is printed with a mark which corresponds to that displayed on the mobile phone screen for alignment, and the mark is marked according to the screen protector for actual type of each mobile phone.

Further, the mark position can be set in the center or four corners of the screen according to habits, and the mark pattern may be a cross or a circle or a triangle, etc.

This invention also provides a method for location protector pasting for mobile phones by using the screen protector above, which includes the following steps:

Step 1, take the mobile phone to be pasted with a screen protector and obtain the screen mark diagram, which displays the mark and mobile phone type as well as resolution information on the mobile phone;

Step 2, clean the mobile phone screen and take a screen protector, which shall be consistent with the type of the mobile phone to be pasted with a screen protector, and the screen protector includes a position alignment layer, a protector layer and a release film layer from top to bottom successively, where the short side of the position alignment layer is set with a first label and a side of the release film layer is set with a second label; take at least one fixing paste, and fix a part of the fixing paste to the long side of the position alignment layer;

Step 3, align the mark on the position alignment layer with the mark displayed on the mobile phone screen, paste the release film layer to the front of the mobile phone closely, and paste the other part of the fixing paste to the lateral edge or back of the mobile phone;

Step 4, pull the second label to remove the release film layer, to paste the protector layer to the mobile phone screen closely;

Step 5, remove bubbles between the protector layer and the mobile phone screen, and pull the first label to remove the position alignment layer.

Further, the screen mark diagram displayed on the mobile phone screen can be downloaded through the WeChat, and open the WeChat to scan the QR code, to follow the official account operated specially for protector pasting. A development mini program is built in the official account or standard screen mark diagrams of various mobile phones currently on the market will be preset in the background of the official account. After reading the official account, the screen mark diagram suitable to that mobile phone type will be obtained and displayed on the screen of the mobile phone to be pasted with a screen protector.

This invention has the following beneficial effects:

1. Through aligning the mark on the screen protector with the mark displayed on the mobile phone screen, to achieve a quick position alignment, and this method is more accurate and more economical comparing with that makes a fixture surrounding the mobile phone to fix the screen protector;

2. This method can achieve the correction protector pasting to all screens including plane or 3D, which is more convenient;

3. This method just needs to print any mark pattern on the surface protector to correct the pasting location on the screen, which can provide the probability to achieve different appearance effects for developers.

### BRIEF DESCRIPTION OF THE DRAWINGS

FIG. 1 is a diagram for a screen protector and a screen mark of an embodiment of this invention; and

FIG. 2 is a diagram for a screen protector of an embodiment of this invention.

### DETAILED DESCRIPTION

In order to make the technical means to achieve this invention clear, this invention will be described further in conjunction with drawings as follows,

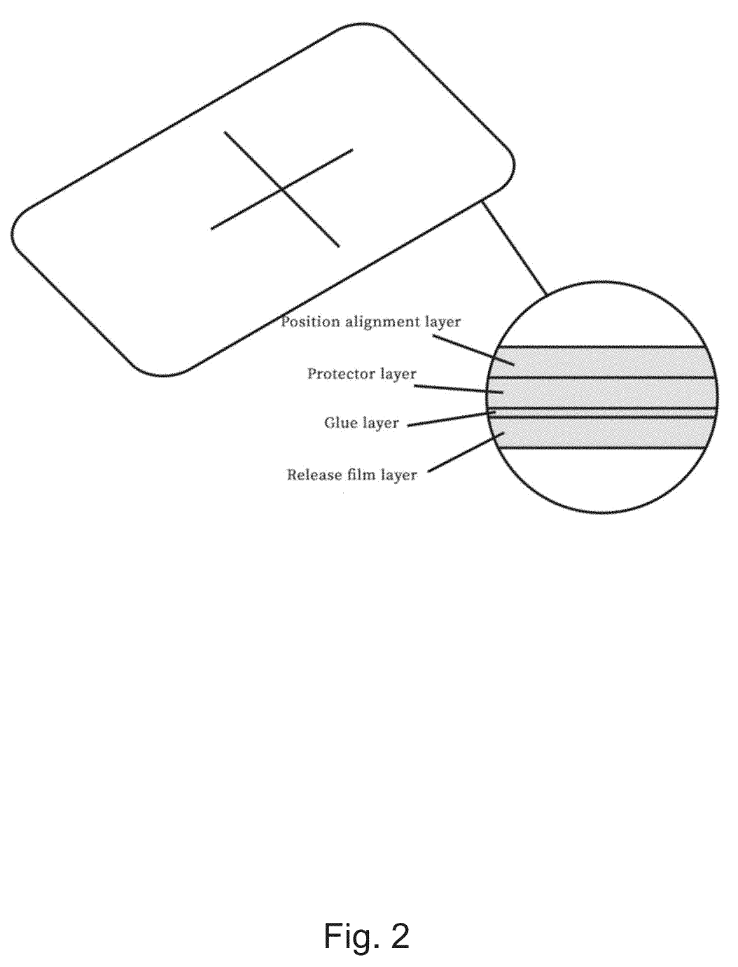

As shown in FIG. 2, it is the screen protector structure of this invention, which includes three layers, i.e. position alignment layer, protector layer and release film layer respectively, and the protector layer is the layer that actually protects the screen and is set between the position alignment layer and the release film layer, where the position alignment layer is set in the outer layer. The protector layer is coated with a glue layer, for pasting with the mobile phone screen, and the position alignment layer and the release film layer are set with labels respectively, the effect of which is to drive its layer to facilitate the removal and separation.

The position alignment layer is printed with a cross mark which corresponds to that displayed on the mobile phone screen for alignment, and the mark is marked according to the screen protector for actual type of each mobile phone. The mark position can be set in the center or four corners of the protector screen according to habits, and the mark pattern may be a circle or a triangle or other patterns that is easy to make the position alignment. This embodiment select the cross, which is a simple and practical position alignment method, and on the position alignment layer, the information of mobile phone type can be printed, to facilitate the user to confirm that the size of this protector corresponds to that of the mobile phone.

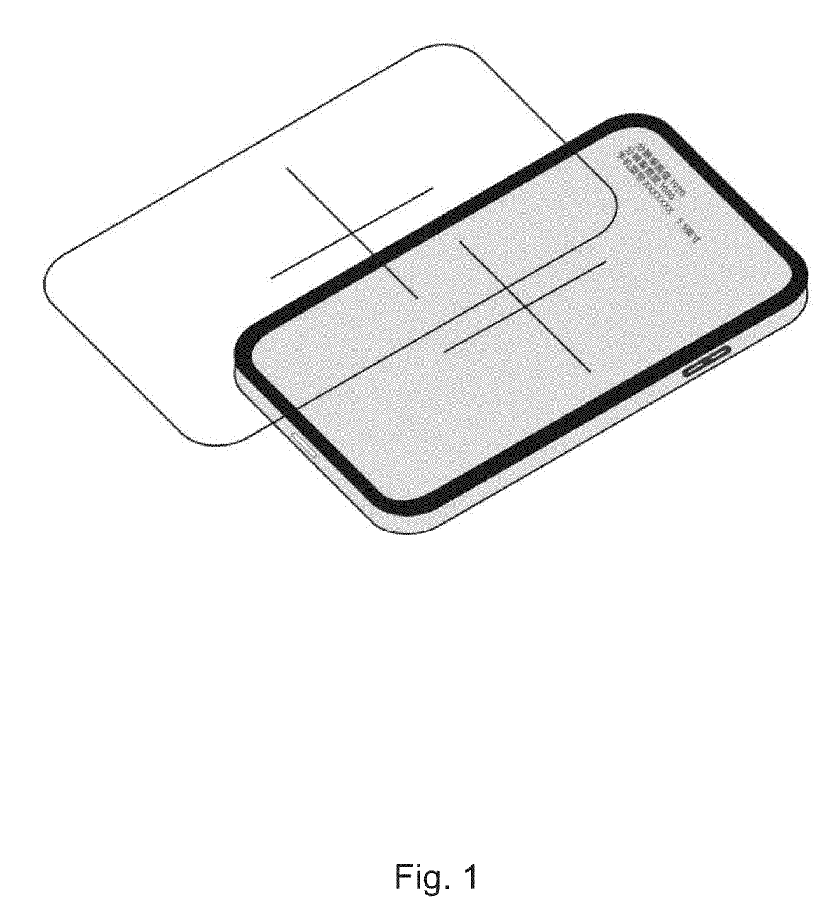

As shown in FIG. 1, it is a diagram for a screen protector and a protector pasting for mobile phones of this invention, and also provides a method for location protector pasting on a mobile phone by using this screen protector, which includes the following steps:

Step 1, take the mobile phone to be pasted with a screen protector and obtain the screen mark diagram, which displays the mark and mobile phone type as well as resolution information on the mobile phone; the screen mark diagram displayed on the mobile phone screen can be downloaded through the WeChat, and open the WeChat to scan the QR code, to follow the official account operated specially for protector pasting. A development mini program is built in the official account or standard screen mark diagrams of various mobile phones currently on the market will be preset in the background of the official account. After reading the official account, the screen mark diagram suitable to that mobile phone type will be obtained and displayed on the screen of the mobile phone to be pasted with a screen protector. This QR code is produced by the seller of the screen protector, used for obtaining the information of mobile phones, and because the existing mobile software can read the hardware information of mobile phones in Android or IOS system, the accurate type and size of that mobile phone can be obtained.

Step 2, clean the mobile phone screen and take a screen protector, which shall be consistent with the type of the mobile phone to be pasted with a screen protector, and the screen protector includes a position alignment layer, a protector layer and a release film layer from top to bottom successively, where the short side of the position alignment layer is set with a first label and a side of the release film layer is set with a second label; take at least one fixing paste, and fix a part of the fixing paste to the long side of the position alignment layer;

Step 3, align the mark on the position alignment layer with the mark displayed on the mobile phone screen, paste the release film layer to the front of the mobile phone closely, and paste the other part of the fixing paste to the lateral edge or back of the mobile phone;

Step 4, pull the second label to remove the release film layer, to paste the protector layer to the mobile phone screen closely;

Step 5, remove bubbles between the protector layer and the mobile phone screen, and pull the first label to remove the position alignment layer.

Among them, the screen mark diagram that displays the position alignment mark on the screen can obtained through but not limited to: the implantation by the WeChat official account, and the pasting mark may also be displayed on the screen by a specially developed software or downloading diagrams.

In addition to the application in protector pasting for mobile phones, it can also be used in the electronic products that needs surface protector pasting such as larger-size tablet personal computers or laptops, etc.

The aforementioned contents are the detailed description for the method for location protector pasting for mobile phones provided by this invention, and this text uses a specific embodiment to describe the structure principle and implementation mode of this invention, where the aforementioned embodiment is only used to help the understanding of the method of this invention and its core concept; at the same time, for general technical personnel in this field, they may make some modifications in specific implementation modes and application scopes according to the concept of this invention, and in summary, the contents of this Specifications shall not be construed as a limit to this invention.

1. A screen protector comprising a position alignment layer, a protector layer, and a release film layer, wherein the protector layer sis configured to protect a mobile phone screen and is set between the position alignment layer and the release film layer, where the position alignment layer is set in an outer layer.

2. The screen protector of claim 1, wherein the protector layer is coated with a glue layer, for pasting with the mobile phone screen, and the position alignment layer and the release film layer are set with labels respectively.

3. The screen protector of claim 1, wherein the position alignment layer is printed with a first mark which corresponds to a second mark displayed on the mobile phone screen for alignment, and the first mark is printed according to the screen protector for actual type of each mobile phone.

4. The screen protector of claim 3, wherein the first mark is set in the center or four corners of the screen, and the first mark is a member selected from a group consisting of a cross, a circle, and a triangle.

5. A method for location protector pasting for mobile phones comprising:
taking a mobile phone to be pasted with a screen protector;
obtaining a screen mark diagram, which displays a first mark, a mobile phone type, and resolution information of the mobile phone on the mobile phone;
cleaning a mobile phone screen of the mobile phone;
taking a screen protector, which is consistent with the mobile phone type to be pasted with the screen protector, wherein the screen protector comprises a position alignment layer, a protector layer, and a release film layer, where a short side of the position alignment layer is set with a first label and a side of the release film layer is set with a second label;
taking at least one fixing paste;
fixing a part of the fixing paste to the long side of the position alignment layer;
aligning a second mark on the position alignment layer with the first mark displayed on the mobile phone screen;
pasting the release film layer to the front of the mobile phone closely;
pasting the other part of the fixing paste to the lateral edge or back of the mobile phone;
pulling the second label to remove the release film layer and to paste the protector layer to the mobile phone screen closely; and
removing bubbles between the protector layer and the mobile phone screen, and pull the first label to remove the position alignment layer.

6. The method for location protector pasting for mobile phones described according to claim 6, wherein the screen mark diagram displayed on the mobile phone screen is downloadable via an application installed on the mobile phone, and wherein the screen mark diagram is generated based on the mobile phone type provided by the application.
